(19) United States
(12) Patent Application Publication
(10) Pub. No.: US 2007/0230287 A1
(43) Pub. Date: Oct. 4, 2007

(54) WATCH MODULE COMPRISING A ROTARY DIAL CAPABLE OF BEING FITTED TO A WATCH MOVEMENT

(75) Inventor: Fawaz Gruosi, Prangins (CH)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: DE GRISOGONO SA, Plan-les-Ouates (CH)

(21) Appl. No.: 11/689,920

(22) Filed: Mar. 22, 2007

(30) Foreign Application Priority Data
Mar. 29, 2006 (EP) EP06006515

(51) Int. Cl. G04B 19/00

(52) U.S. Cl. 368/223

(57) ABSTRACT

Watch module comprising a rotary dial (1) possessing an opening (2) for displaying a complication or an image. This rotary dial (1) is mounted rotatably on a base dial (3) via an annular low-friction member (4). This rotary dial (1) can be pivoted through a certain angle by the action of a pusher (9, 9′) to display another complication or image through the opening (2). This watch module, which comprises means (8, 13, 19, 21) for arresting and coupling the rotary dial (1) to the base dial (3), is arranged on the one hand in such a way as to decouple the rotary dial (1) from the base dial (3) when the pusher (9, 9′) is pushed, and on the other hand to drive the rotary dial (1) when the pusher (9, 9′) is released.

The present invention relates to horology, and more particularly to a watch module comprising a rotary dial capable of being fitted to a watch movement. The dial possesses an opening for displaying only one of the complications of the watch movement, the action of a pusher being used to pivot said dial in order to display another complication or an image.

Most mechanical watches with so-called complicated work indicate other information than merely the time. Some complications such as the indication of a watch's power reserve, a perpetual calendar or the phases of the moon, for example, are put on the watch dial. Putting several complications into one watch can overload the dial and make the information difficult to read. Too much information can also detract from the dignity of the watch.

It is an object of the present invention to provide a watch module comprising a rotary dial capable of being fitted to a watch movement, said rotary dial possessing an opening for displaying one type of information at a time in order both to facilitate the reading of the information and raise the tone of the watch.

In accordance with the invention, this object is achieved with a watch module comprising a rotary dial possessing an opening for displaying a complication. This rotary dial is mounted rotatably on a base dial via an annular low-friction member. Said rotary dial can be pivoted through a certain angle by the action of a pusher to display another complication or image through the opening. The decoupling of the rotary dial from the base dial preferably occurs when pressure is applied to the pusher, the rotation of the rotary dial being triggered when the pusher returns to its rest position.

The features of the invention will become clearer in the course of reading a description of one embodiment offered purely as a nonlimiting example, with reference to the diagrammatic figures, in which:

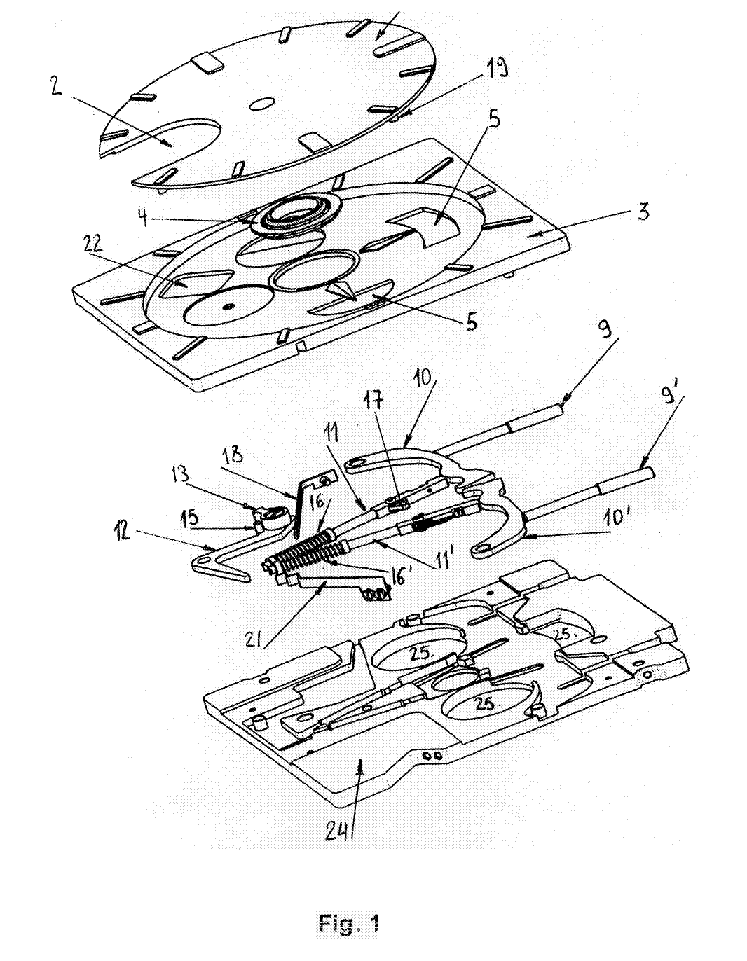

FIG. 1 is an exploded view of the watch module comprising the rotary dial, a base dial, two control systems and a plate;

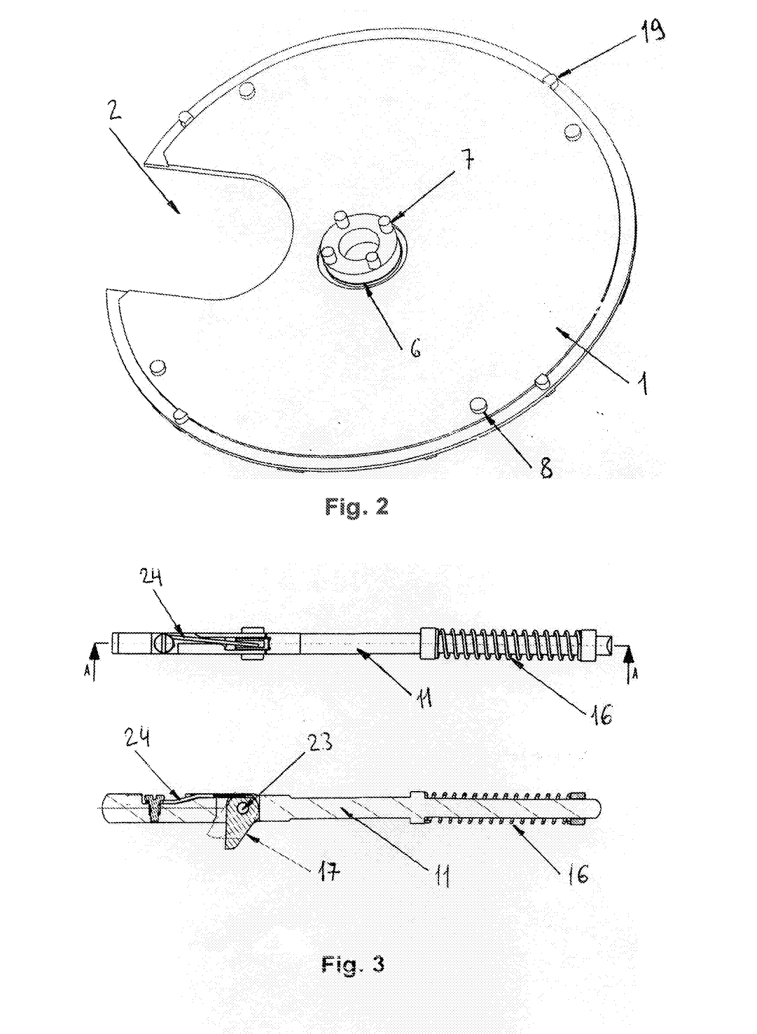

FIG. 2 is a bottom view of the rotary dial comprising four so-called driving pins, four so-called stop pins and four humps;

FIG. 3 is a rear view of a control rod comprising a hook and a cross section taken on A-A through said rod;

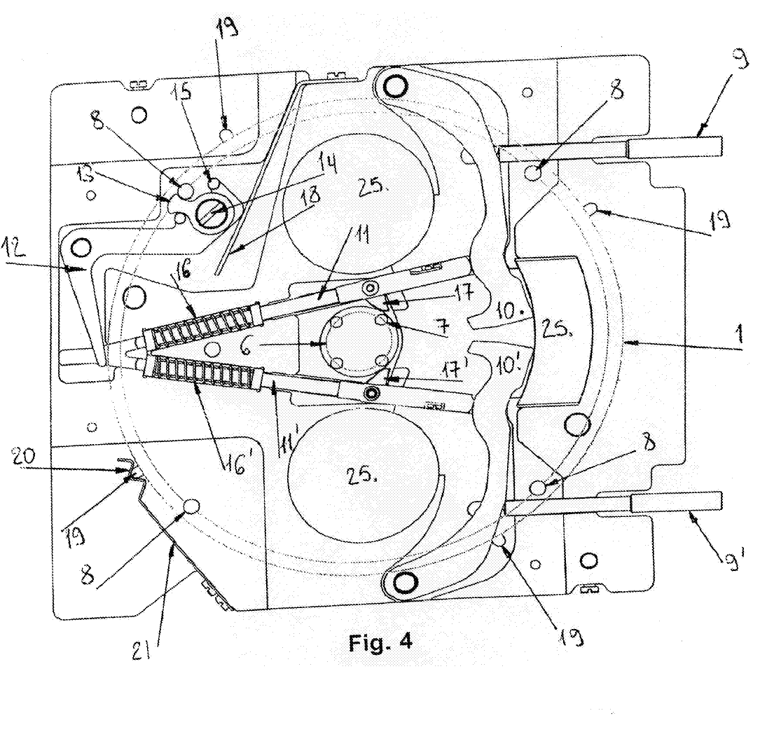

FIG. 4 is a top view of two control systems laid out on the plate in the initial position, the rotary dial being depicted in phantom lines;

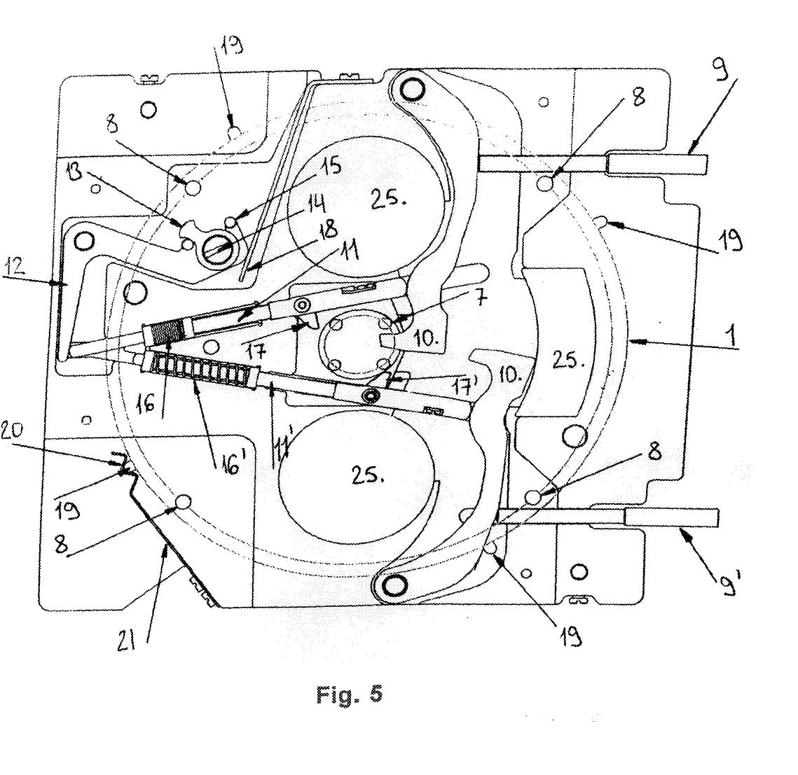

FIG. 5 is a top view of FIG. 4 when one of the pushers is operated and its control rod is at full stroke;

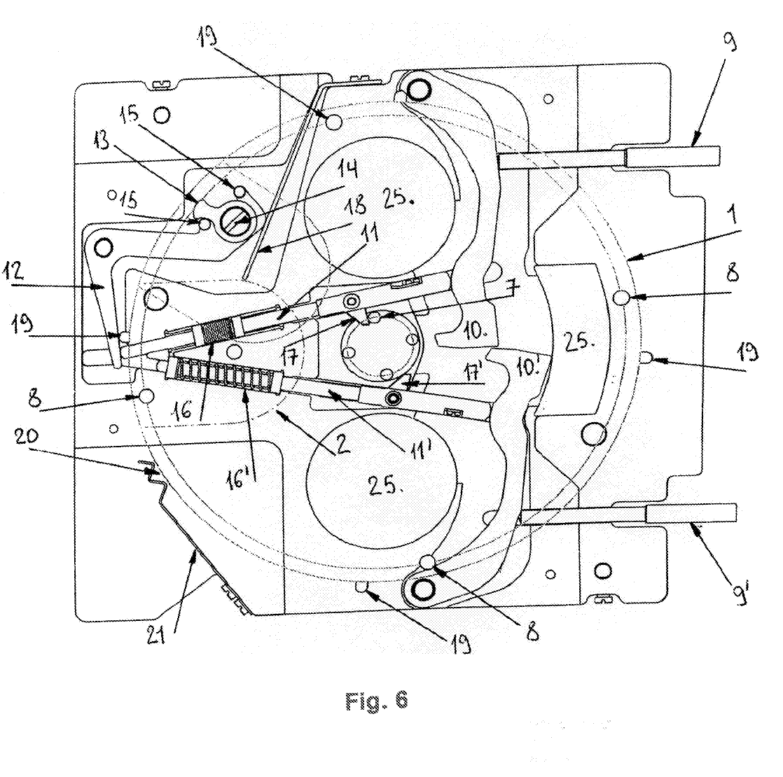

FIG. 6 is a top view of FIG. 5 when the rotary dial is rotating; and

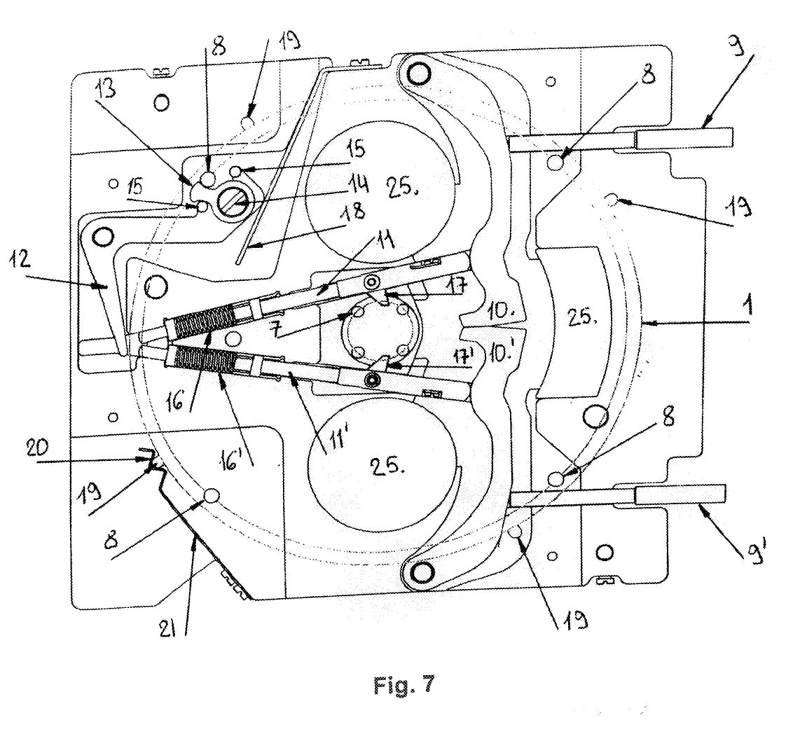

FIG. 7 is a top view of FIG. 4 when the two pushers are operated simultaneously.

In the main embodiment of the present invention, the watch module comprises the rotary dial (1) which includes the opening (2). Said dial (1) is able to rotate on the base dial (3) via a ball bearing (4). The base dial (3) has four openings (5) each set out at 90° to allow four complications of the watch movement to be seen.

On the underside of the rotary dial (1) there are on the one hand an annular part (6) in its center, on which the four driving pins (7) are positioned at regular intervals, and on the other hand the other four stop pins (8) positioned around its periphery, also at regular intervals matching the driving pins (7).

Each of the four driving pins (7) is designed to be driven by an instantaneous mechanism, which will be described later, in order to turn the rotary dial (1) through 90° when a pusher (9, 9′) is operated. Each of the stop pins (8) is designed to stop the rotary dial (1) turning once it has rotated through 90°.

Since the watch module has two identical control systems located symmetrically about the three o'clock/nine o'clock axis, one turning the rotary dial (1) clockwise and the other turning it counter clockwise, only the action of one of these systems will be described.

The control system, the purpose of which is to cause the rotary dial (1) of the module to pivot clockwise, comprises the following sequences:
the pusher (9) operates a transmission rocker (10) that transmits a rectilinear movement to a rod (11) until one of its ends operates a so-called stop rocker (12);
under the action of said rod (11), this rocker (12), which has a stop finger (13) that can pivot freely about a pivot pin (14) between two pins (15) that limit the movement of the finger (13), pivots in order momentarily to disengage the stop finger (13) from one of the stop pins (8) (FIG. 5);
under the action of a return spring (16) arranged on the rod (11), the rod (11) is moved back in a straight line when the pusher (9) ceases to be operated, and this brings a hook (17) connected to the rod (11) into contact with one of the driving pins (7);
as the return spring (16) continues to push, the hook (17) drives the driving pin (7), which causes the rotary dial (1) to rotate in a clockwise direction (FIG. 6);
the rod (11) then returns to its rest position;
at this point, under the action of a leaf spring (18), the stop rocker (12) has returned to its initial position, thus allowing the next stop pin (8) to be stopped by the stop finger (13) once the rotary dial (1) has pivoted through 90°.

When it is operated, the pusher (9) triggers an instantaneous rotation of the rotary dial (1) through the various sequences mentioned above. However, when one of the stop pins (8) is arrested by the stop finger (13), the rotary dial (1), having turned 90°, is now in an unstable position. To alleviate this problem, on the perimeter of the rotary dial (1) there are four humps (19) corresponding to the stop pins (8). The humps are designed to click one at a time into a housing (20) formed in a leaf spring (21) and thereby stabilize the rotary dial (1). This leaf spring (21) is mounted in a well (not shown) in the base dial (3).

The base dial (3) has an extra opening (22) (FIG. 1) at ten o'clock in order to position the finger (13) of the so-called stop rocker (12) at the stop pins (8).

The hook (17) is loosely fitted to the rod (11) about a pin (23) perpendicular to the rod (11) (FIG. 3). A spring (24) is screwed to said rod (11) in such a way that one of its ends rests on the nub of the hook (17) pushing it out to project at 90° from the rod (11). The hook (17) can thus retract on contact with one of the four driving pins (7) which means that the rod (11) does not jam when the pusher (9) is operated.

The various component parts of the control system described above and of the control system for turning the rotary dial (1) of the module in the counter clockwise direction by the action of a pusher (9′) are laid out on a plate (24) which is intended to be positioned directly over the watch movement. Said plate (24) has openings (25) aligned with the openings (25) of the base dial (3) so that the four complications of the watch movement can be seen.

The symmetrical shaping and positioning of the two transmission rockers (10, 10′) allow only one pusher (9, 9′) to be operated at a time, since simultaneous pressure on said pushers will immobilize both control systems (FIG. 7).

The embodiment is in no sense restrictive and consequently the number of driving and stop pins (7, 8) may be less or greater than four in order to vary the angle of rotation of the rotary dial (1) when the pusher (9) is operated. The intervals between said driving and stop pins (7, 8) do not have to be regular. In addition, designs may replace one or more complications of the watch movement.

1. A watch module capable of being fitted to a watch movement, said module comprising a rotary dial (1) possessing an opening (2) for displaying a complication of the watch movement or an image, in which module said rotary dial (1) is mounted rotatably on a base dial (3) via an annular low-friction member (4), the rotary dial (1) being able to be pivoted through a certain angle by the action of a pusher (9) to display another complication or image through the opening (2).

2. The watch module as claimed in claim 1, comprising means (8, 13, 19, 21) for arresting and coupling the rotary dial (1) to the base dial (3), said module being arranged on the one hand in such a way as to decouple the rotary dial (1) from the base dial (3) when the pusher (9, 9′) is pushed, and on the other hand to drive the rotary dial (1) when the pusher (9, 9′) is released.

3. The watch module as claimed in claim 2, in which the underside of the rotary dial (1) comprises on the one hand several so-called driving pins (7) arranged at regular or irregular intervals on a circle (6) situated close to its center, and on the other hand several so-called stop pins (8) positioned on its perimeter at regular or irregular intervals, the action of the pusher (9) causing a transmission rocker (10) to pivot and communicate a rectilinear movement to a rod (11) until one of its ends operates a so-called stop rocker (12) comprising means for stopping the stop pins (8), which stop rocker (12) pivots in order momentarily to disengage one of said stop pins (8) from said stop means, said rod (11) comprising a return spring (16) allowing it to regain its rest position when the pusher (9) is no longer being operated, the rod (11) taking with it as it passes one of the driving pins (7) by means of a hook (17), thereby triggering the rotation in a first direction of rotation of the rotary dial (1), and the latter pivoting until the next stop pin (8) is stopped by the stop means of the stop rocker (12).

4. The watch module as claimed in claim 3, comprising a second pusher (9′) that causes a second transmission rocker (10′) to pivot when the second pusher (9′) is operated, which second rocker (10′) transmits a rectilinear movement to a second rod (11′) until one of its ends operates the stop rocker (12), said second rod (11′) comprising a second return spring (16′) allowing it to regain its rest position when the second pusher (9′) is no longer being operated, taking with it as it passes one of the driving pins (7) by means of a second hook (17′), thereby triggering a rotation in the opposite direction to said first direction of the rotary dial (1).

5. The watch module as claimed in claim 4, in which the shaping and positioning of the two transmission rockers (10, 10′) allow only one pusher (9, 9′) to be operated at a time.

6. The watch module as claimed in claim 1, in which the means for stopping the stop rocker (12) comprise a stop finger (13) that can pivot freely about a pivot pin (14) and two pins (15) that limit the movement of said finger (13).

7. The watch module as claimed in claim 6, in which the perimeter of the rotary dial (1) has several humps (19) designed to click one at a time into a housing (20) formed in a leaf spring (21) when one of the stop pins (18) is stopped by the stop finger (13), thereby holding the rotary dial in a fixed position.

8. The watch module as claimed in claim 4, in which each hook (17, 17′) is loosely fitted to its rod (11, 11′) about a pin (23, 23′) perpendicular to said rod (11, 11′), a spring (24, 24′) being mounted on the rod (11, 11′) in such a way that it rests on the nub of the hook (17, 17′), pushing it out from the rod (11, 11′), and the hook (17, 17′) retracting on contact with the driving pin (7) when the rod (11, 11′) is being operated by the transmission rocker (10, 10′).

9. The watch module as claimed in claim 1, in which there are equal numbers of driving pins (7), stop pins (8) and, where applicable, humps (19) and they are in matching positions.

10. The watch module as claimed in claim 9, comprising four driving pins (7), four stop pins (8), and four humps (19).

11. A watch comprising the watch module as claimed in claim 1.

12. The watch module as claimed in claim 2, in which the means for stopping the stop rocker (12) comprise a stop finger (13) that can pivot freely about a pivot pin (14) and two pins (15) that limit the movement of said finger (13).

13. The watch module as claimed in claim 3, in which the means for stopping the stop rocker (12) comprise a stop finger (13) that can pivot freely about a pivot pin (14) and two pins (15) that limit the movement of said finger (13).

14. The watch module as claimed in claim 4, in which the means for stopping the stop rocker (12) comprise a stop finger (13) that can pivot freely about a pivot pin (14) and two pins (15) that limit the movement of said finger (13).

15. The watch module as claimed in claim 5, in which the means for stopping the stop rocker (12) comprise a stop finger (13) that can pivot freely about a pivot pin (14) and two pins (15) that limit the movement of said finger (13).

16. The watch module as claimed in claim 2, in which there are equal numbers of driving pins (7), stop pins (8) and, where applicable, humps (19) and they are in matching positions.

17. The watch module as claimed in claim 3, in which there are equal numbers of driving pins (7), stop pins (8) and, where applicable, humps (19) and they are in matching positions.

18. The watch module as claimed in claim 4, in which there are equal numbers of driving pins (7), stop pins (8) and, where applicable, humps (19) and they are in matching positions.

19. A watch comprising the watch module as claimed in claim 4.

20. A watch comprising the watch module as claimed in claim 9.
